(19) United States
(12) Patent Application Publication
(10) Pub. No.: US 2014/0149329 A1
(43) Pub. Date: May 29, 2014

(54) NEAR REAL TIME BLOOD GLUCOSE LEVEL FORECASTING

(71) Applicant: Stephen Shaw, Newtonabbey (GB)

(72) Inventor: Stephen Shaw, Newtonabbey (GB)

(21) Appl. No.: 13/866,612

(22) Filed: Apr. 19, 2013

Related U.S. Application Data
(60) Provisional application No. 61/635,364, filed on Apr. 19, 2012.

(51) Int. Cl. G06N 5/02

(52) U.S. Cl. CPC G06N 5/02
USPC 706/46

(57) ABSTRACT

A method of forecasting optimal insulin dosage levels calculates a near real time blood glucose forecast based on frequently updated data representative of blood glucose levels and displays a near real time blood glucose forecast to a user.

### CROSS-REFERENCE TO RELATED APPLICATIONS

This application claims priority to U.S. Provisional Application No. 61/635364, which was filed on Apr. 19, 2012 and is incorporated herein by reference.

### TECHNICAL FIELD

The present disclosure relates to glucose tracking for diabetic patients, and more particularly to a method and device for optimizing a dosage of insulin.

### BACKGROUND OF THE INVENTION

Diabetes patients, and patients with short-term hyperglycemia occurring during a hospitalization for another illness (such as pneumonia or a myocardial infarction), suffer from complications related to high and/or low blood glucose levels (BG). Insulin is administered to these patients to regularize their blood glucose levels. In many cases, the insulin is self-administered. Deciding the timing, dose and type of insulin to use is critical to controlling blood glucose levels. The current blood glucose measurement and administration techniques fail to consistently maintain the normal levels that a healthy person with a normally functioning pancreas would achieve.

Part of the challenge for patients and their caregivers is the constant changes in blood glucose levels, the lag time between taking insulin and its impact, and the longevity of each type of insulin, which can stay in the patients system for up to 24 hours. Typically, the administered dosage is a “best guess” based on experience, and not specific to exactly what is required for a given individual at a given moment in time, which is what a functional pancreas is capable of doing. These “best guess” experiential doses benefit patients, but are far from perfect, and diabetics are still at an elevated risk of related health issues and shorter lives than non-sufferers.

The advent of Constant Glucose Meters (CGMs) and Insulin Pumps has made measuring blood glucose and administering insulin much more frequent, and hence offers substantial opportunity for each patient to avoid highs and lows, and improve their overall health prospects. Constant glucose meters typically measure glucose in interstitial fluids, not directly in blood, as a proxy for actual blood glucose levels. References in this disclosure to blood glucose data also refer to proxy blood glucose data. Currently known devices are limited to “rear view” trending to guess what levels of insulin are appropriate.

The disclosed method and device helps forecast, scenario plan and optimize the dosage of insulin that is required at any moment in time for a specific patient, based on forward looking mathematical projections.

### SUMMARY OF THE INVENTION

Disclosed is a method of forecasting optimal insulin dosage levels including the steps of: calculating a near real time blood glucose forecast based on frequently updated data representative of blood glucose levels, and displaying the near real time blood glucose forecast, thereby allowing a user to determine an appropriate dosage based on the near real time blood glucose forecast.

Also disclosed is a method of monitoring a near real time blood glucose forecast including the steps of: determining a near real time blood glucose forecast, and transmitting an alert based on said near real time blood glucose forecast, wherein the alert indicates an expected future high or low blood glucose level.

Also disclosed is a blood glucose forecasting system including a near real time blood glucose forecast including a processor, a computer readable memory storing instructions for causing the processor to perform the steps of calculating a near real time blood glucose forecast based on frequently updated data representative of blood glucose levels and displaying the near real time blood glucose forecast, thereby allowing a user to determine an appropriate dosage based on said near real time blood glucose forecast, a data input operable to at least receive periodic data representative of blood glucose levels, an output medium comprising at least one of the list of a portable device screen, an electronic message transmission, and an audible output component.

These and other features of the present invention can be best understood from the following specification and drawings, the following of which is a brief description.

### BRIEF DESCRIPTION OF THE DRAWINGS

FIG. 1 illustrates a method for generating a near real time blood glucose level forecast.

FIG. 2A illustrates a first example blood glucose forecasting system.

FIG. 2B illustrates a second example blood glucose forecasting system.

FIG. 3 illustrates an example near real time blood glucose level forecast.

FIG. 4a illustrates a first portion of two portions of an example master event event database.

FIG. 4b illustrates a second portion of two portions of an example master event database.

### DETAILED DESCRIPTION OF AN EMBODIMENT

As described previously, individuals with diabetes, or other conditions that result in high and/or low blood glucose levels, require insulin or other medications whose dosages vary depending on many environmental conditions. Often, the environmental conditions affecting blood glucose levels are part of a routine and/or standard environmental conditions that can occur with relative frequency. Current best practice in the field is to assign a “best guess” dosage that attempts to account for standardized environmental conditions, and does not account for varied conditions. As a result, the actual dosages administered are not as accurate as desirable, even when a constant glucose meter is utilized. This is particularly true with regards to self-administered insulin dosages. Attempts to correct for changing environmental conditions require a discussion with a caregiver, such as a clinician, and the time period for administering the dosage may pass before the accurate dosage can be determined. For this reason, corrections in existing methods are limited to a hindsight based approach (alternatively referred to as a rear looking estimate).

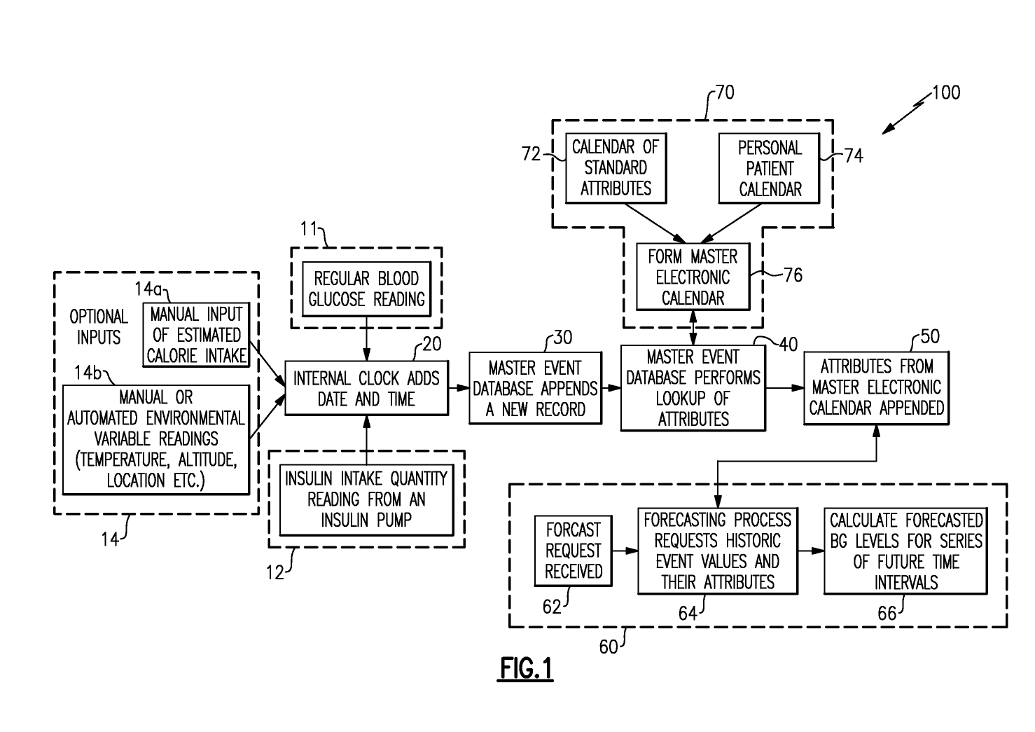

FIG. 1 illustrates a process 10 by which a blood glucose forecasting system can generate a near real time blood glucose level forecast. The blood glucose forecasting system initially receives regular input values from a blood glucose forecasting system reading input 11. In addition to the blood glucose forecasting system readings 11, the blood glucose forecasting system receives an insulin quantity input 12. The insulin quantity input 12 can be manually entered by a patient or caregiver whenever insulin is administered. In alternate examples an automated machine, such as an insulin pump, automatically provides the insulin quantity input 12 to the blood glucose forecasting system. In some examples, multiple optional inputs 14 can also be included. In one example, the patient or caregiver manually inputs an estimated calorie intake as a calorie intake input 14a. In another example, the patient or caregiver manually enters, or an automated system generates, environmental variable readings such as temperature, altitude, location etc. as an environmental variable reading input 14b.

When the blood glucose forecasting system receives any of the above inputs 11, 12, 14, a processor within the blood glucose forecasting system adds a date and time stamp to the input in an “internal clock adds date and time” step 20. The processor then adds a new record reflecting the input 11, 12, 14 to a master event database in a “master event database appends new record” step 30. In most examples, the master event database is stored locally in a memory of the blood glucose forecasting system.

Once the new entry in the master event database has been generated, the processor polls a master electronic calendar 70 for any attributes to be associated with the new record in a “master event database performs lookup of attributes” step 40. Any attributes in the master electronic calendar 70 to be associated with the new record are added to the new record in an “attributes from master electronic calendar appended to record” step 50.

By following steps 20, 30, 40 and 50 for each new record, a personal patient history is generated within the blood glucose forecasting system. In some examples the blood glucose forecasting system is pre-loaded with a general patient history reflecting trends and inputs of a general population, and the personal patient history is built on top of the foundation provided by the general patient history. Once a personal patient history is established, the blood glucose forecasting system uses the personal patient history in a near real time glucose level forecasting process 60.

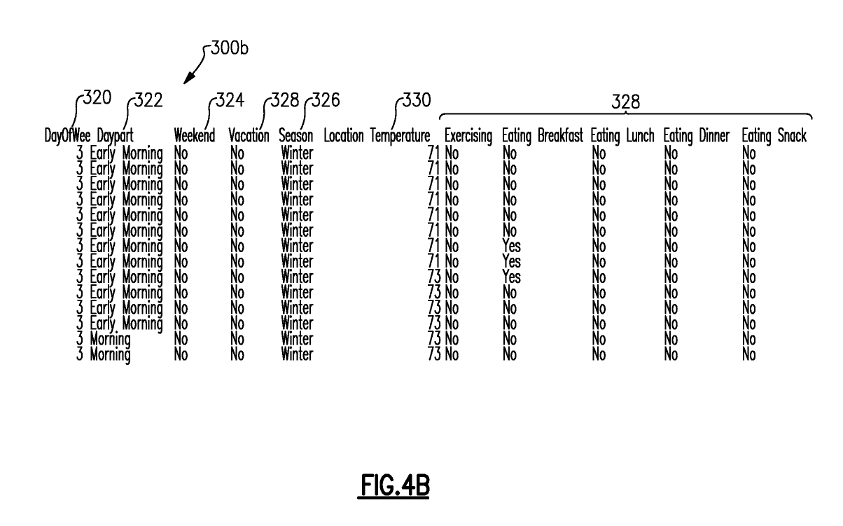

FIGS. 4a and 4b illustrate an example master event database 300 generated by the blood glucose forecasting system 100. In the example master event database 300, each reading from a blood glucose meter is assigned a date 302 and time 304 when the reading is received in the “internal clock adds date and time” step 20, and the reading is added as a new event (entry) to the master event database in the “master event database appends new record” step 30. In some examples, multiple patient histories are included in the master event database 300. In such examples a patientID 306 is assigned to the database entry as well. Each reading includes a blood glucose reading 308, a basal insulin intake reading 310, a bolus insulin intake reading 312, a total insulin intake reading 314, and an onboard insulin reading 316. Some example master event databases also include a timezone indicator 318 indicating the time zone in which the patient was when the reading was taken.

In the “master event database performs lookup of attributes” step 40, additional variables and attributes such as day of the week 320, daypart 322, weekend 324, and season 326 are added from the calendar of standard attributes 72. Further variables and attributes 328 are added from the personal patient calendar 74, such whether the patient is on vacation, and whether the patient was exercising or eating a particular meal during the corresponding timeslot.

In yet further examples, the master event database can include input attributes 330, such as a local temperature where the patient is located, relating to environmental factors. In such an example, the additional input attributes 330 are received in a manner similar to the personal patient calendar.

In one alternate example process, the “attributes from master electronic calendar appended” step 50 can be omitted, and the near real time blood glucose level forecasting process 60 can draw values directly from the “master event database performs lookup of attributes” step 40.

The aforementioned master event calendar 70 is further illustrated in FIG. 1. The processor of the blood glucose forecasting system receives a calendar of standard attributes as a calendar of standard attributes input 72. The standard attributes reflect normal, recurring, events and attributes corresponding to those events. In some examples the events include days of the week, months, seasons, time periods within a day, and other similar recurring events. In some example blood glucose forecasting systems a patient or caregiver can also manually enter a personal patient calendar as a personal patient calendar input 74. The personal patient calendar reflects both past and expected future non-recurring personal events, and their corresponding attributes, such as vacations, travel days, exercise routines, and any similar events. The processor then aggregates these inputs 72, 74 into a single master event calendar in a “form master electronic calendar” step 76. The master electronic calendar 70 can further be updated or appended by a patient or caregiver after the master electronic calendar 70 has been formed using a similar input process.

The aforementioned forecasting process 60 is initiated in a “forecast request received” step 62. The request can be triggered by a patient or caregiver manually requesting a forecast, or by an automated forecast request triggered either periodically or in response to a specific event in the master event database, for a specific future time period such as the next 3 hours. Once triggered, the forecasting process 60 polls the master event database for all relevant historic event values and their corresponding attributes in a “forecasting process requests historic event values and their attributes” step 64, and all seasonal attributes and expected future events within the forecast time period. In one example the forecast time period is three hours.

Once all the relevant event values and attributes have been retrieved, the forecasting process 60 calculates a set of forecasted blood glucose levels for a series of future time intervals for the forecast period based on historic event values and attributes in a “calculate forecasted blood glucose levels for a series of future time intervals” step 66. The processor determines the forecast in near real time using a predictive time series model.

The above described process is a combination of a time series model and constant blood glucose level measurement techniques. The forecast forecasts the expected optimal dosage of insulin using a predictive modeling technique. In one example, the time series model is based on vector autoregression using seasonal and lifestyle related exogenous variables. Further, blood glucose levels are a Multivariate Time Series, and vector autoregression is an appropriate technique to generate blood glucose level forecasts.

The application of the seasonal and lifestyle related exogenous variables from the master electronic calendar 70 to an existing blood glucose level data set allows the predictive model to be self-learning, and to compensate for the effects of expected exogenous variables and events for a particular patient. Applying the complex self-learning forecasts, significantly reduces the likelihood of over or under dosing on insulin. In other examples, the time series model can be moving average modeling, weighted moving average modeling, autoregressive moving average (ARMA) modeling, autoregressive integrated moving average (ARIMA) modeling, Kalman filtering modeling, state space modeling, Bayesian theory based modeling, or any combination of the preceding modeling methods or similar modeling methods.

The time series model can further compensate for the presence of one or more indicator variable, such as seasonal factors, environmental factors and lifestyle factors. Indicator variables are any common or repeated occurrences that have a known or expected effect on blood glucose levels and are represented by the standard attributes 72 in the master electronic calendar 70. By way of non-limiting example, indicator variables can include a time of day, a day of the week, a month of the year, a current weather condition, a change in routine, a menstrual cycle status, a body weight change, a current stress level, a current mood, or any similar factor. Note that the mathematic model would typically convert these values to equal 1 when true, and zero when false. For example a variable “Monday” would have a value of 1 for all records where the day of week was a Monday, and zero for all other days of the week.

In some examples, the time series modeling also includes a “what if” scenario modeling feature. In examples including the what if scenario modeling feature, the patient or caregiver can input one or more scenarios, or possible future events, and the forecast compensates for the scenario or possible future event. By way of example, the patient or caregiver can input a scenario or planned activity into the master electronic calendar 70, and the near real time forecasting of the time series model adjusts the forecast to compensate for the planned activity. In this way, the patient or caregiver can determine the probable effects of the scenario or event and can plan accordingly.

By way of non-limiting example, the planned activity can be taking a predefined planned dosage, planning an exercise time and duration, planning a caloric intake (such as a specific meal), showering, shopping, etc. Similarly, a scenario can include scenarios such as “what if I extend my exercise duration today,” “what if I skip lunch today,” “what if I took an extra unit of insulin today” etc. By tracking the known effects of previous events on blood glucose levels using the self-learning modeling, the predictive model can further isolate the impact of each specific scenario, providing the patient with more complete information as to the affects certain scenarios will have on their blood glucose levels.

Incorporating the what-if scenario modeling further allows the patient or caregiver to analyze the predicted long term effects of particular lifestyle changes. Further, in some examples, the what-if scenario modeling allows the forecast to suggest optimal insulin intake levels and lifestyle changes to achieve desired blood glucose levels.

In the above described general patient history aspect, the projections are improved by applying the historical data of multiple patients to the time series modeling. This can be done based on a database of historic data of multiple patients, with the database being updated frequently, or in real time. Alternatively, the database can be pre-loaded with multiple patients' historic data, and the time series model can self-learn using new data from the specific patient the model is applied to. Multiple patients can mean a small group of patients, or a large population of patients.

The forward looking forecast generated in the forecasting process 60 allows optimization of an intake dosage and type of insulin using any insulin administration method by forecasting and recommending a specific insulin dosage. In some examples an additional forecast of insulin requirements can be generated based on the forecasted blood glucose levels generated in the “calculate forecasted blood glucose levels for series of future time intervals” step 66. In one particular example, the near real time blood glucose level forecast is applied to an “artificial pancreas” device, such as an insulin pump, that combines the above described near real time blood glucose level forecasting and an automated form of insulin administration. In the case of an insulin pump, the forecasting can allow either manual or automatic adjustment to the insulin dosage amount. In an alternative configuration, the adjustment is semi-automatic, and the user can override the automated adjustments.

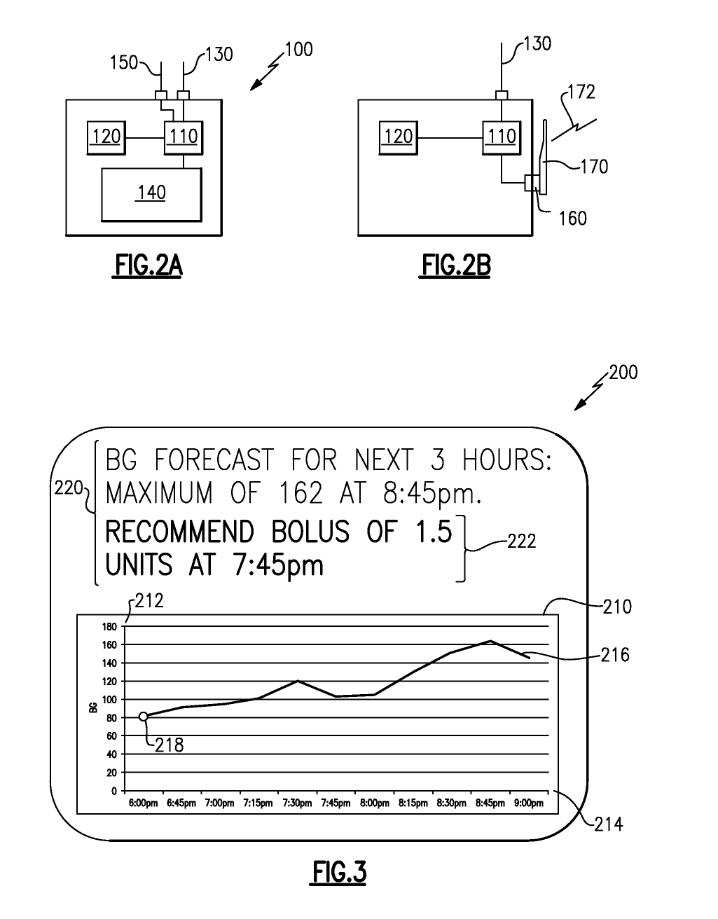

FIGS. 2A and 2B illustrate blood glucose forecasting systems 100 including the above described near real time blood glucose level forecasting process 10. FIG. 2A illustrates a blood glucose forecasting system 100 including a local output screen 140, and FIG. 2B illustrates a blood glucose forecasting system that does not include a local output screen. Each of the blood glucose forecasting systems 100 includes a processor 110 and a memory 120. The memory 120 stores the historic blood glucose data required to enable the fore looking near real time blood glucose level forecasting described above, while the processor 110 is functional to perform the calculations to generate the forecast. Each of the blood glucose forecasting systems 100 further includes a constant blood glucose level input 130 that provides the processor 110 with a constantly updated blood glucose level according to known constant blood glucose meter techniques. The forecast is generated by the processor 110 based at least in part on the received blood glucose levels from the blood glucose meter input 130 and on the historic modeling data stored in the memory 120. In some alternate examples, the processor 110 is omitted, and the data is transmitted to a remote computing device where the forecast is generated. In these examples, the forecast is then transmitted back to the blood glucose forecasting system 100 for the patient's access in near real time.

In some example systems, the blood glucose forecasting system 100 can include an additional scenario/event input 150 that allows the patient and/or caregiver to input scenarios and events and the processor 110 can compensate for those events in the output forecast. In the illustrated example of FIG. 2B, these inputs are done wirelessly and can be received by the transmitter/receiver 160 and transmitted to the processor 110.

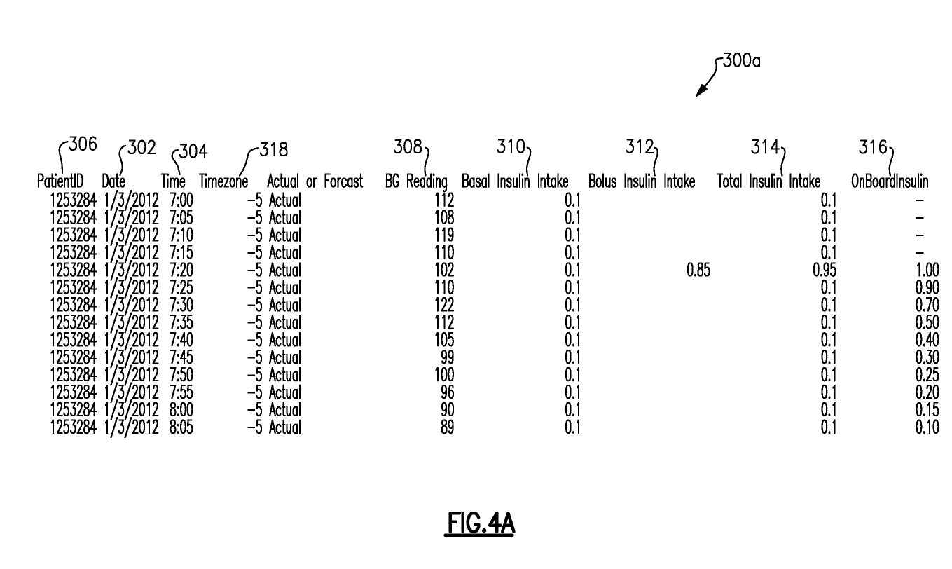

Once the forecast is generated, the forecast is output to the patient or caregiver in an appropriate manner. In the case of the blood glucose forecasting system 100 of FIG. 2A, the forecast is output as a chart displayed on an output screen 140, demonstrating future blood glucose trends based on the most recent information. FIG. 3 illustrates an example output chart and is discussed below. In the case of blood glucose forecasting system 100 of FIG. 2B, the output is sent from the processor 110 to a transmitter/receiver 160 that includes an antenna 170. The forecast is transmitted from the antenna 170 as a wireless message 172 to a remote device capable of informing the patient or caregiver of the near real time blood glucose level forecast. The remote device can be a device disconnected from the blood glucose forecasting system 100 but local to the patient, such as a medical device, a portable phone, a personal computer, or a portable tablet. Alternately, the remote device can be a device remote from the patient, such as a computer at a caregiver's medical facility. The wireless message 172 can be a blue tooth message, Wi-Fi message, cellular data message, or any other type of wireless output.

In certain examples, such as some hospital environments, where a wireless signal may be undesirable, the wireless input/output can be replaced with a hardline connection to a remote device.

In an alternate example, the output screen 140 can be a touchscreen and the patient or caregiver can input information via the screen 140. In yet another alternate example, the blood glucose forecasting system 100 can include an additional input device allowing for direct input of the scenario or event information.

FIG. 3 illustrates an example output forecast 200 including a chart portion 210 and an informational portion 220. The chart portion 210 includes a line graph having an x-axis 214 showing a time, and a y-axis 212 indicating a blood glucose level. A forecasted blood glucose level 216 is displayed for each time interval on the y-axis as a continuous line graph beginning at a start time 218. In alternate examples, the chart portion 210 can include additional information such as a maximum or minimum blood glucose level, a divergent forecast showing the glucose levels 216 if a conditional event does or does not happen, (the “what if” scenario) or any other graphical information.

In the informational portion 220, textual information is provided describing the forecast including a recommended dosage and time for a next medication. In example blood glucose forecasting systems 100 including a remote notification, such as an SMS message or e-mail, the information in the informational portion can be provided via the remote notification without the accompanying chart portion 210.

In one example configuration, the near real time blood glucose level forecast can include triggers or alarms that provide a notification to the patient or caregiver that a dosage is due, a blood glucose level is decreasing rapidly or is spiking, or of any other trigger. The notification is in some examples an auditory alarm, such as a beep pattern, a flashing light, or another cue directing the patient or caregiver to examine the forecast output. In other examples the notification provided can be in the form of a cellular phone call, text message, or e-mail including information and/or instructions with regard to the portion of the forecast that triggered the notification. In some examples, the provided instructions can include a recommended timing or amount for a caloric intake, a recommended amount of exercise, or a recommended insulin dosage.

In another example configuration, such as the physical device illustrated in FIG. 2B, a caregiver can remotely access a patient's near real time blood glucose forecast by logging in wirelessly, or over the internet. In this way, a remote caregiver can monitor a patients near real time blood glucose level forecast.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A method of forecasting optimal insulin dosage levels comprising the steps of:
calculating a near real time blood glucose forecast based on frequently updated data representative of blood glucose levels; and
displaying the near real time blood glucose forecast, thereby allowing a user to determine an appropriate dosage based on said near real time blood glucose forecast.

2. The method of claim 1, wherein said step of calculating a near real time blood glucose forecast based on frequently updated data representative of blood glucose levels further comprises:
initiating a forecasting process in response to a forecast request;
accessing a plurality of historic event values and corresponding attributes from a master event record;
generating the near real time blood glucose forecast based on the historic event values and corresponding attributes using a predictive time series model.

3. The method of claim 2, wherein said predictive time series model selected from the list of time series time series modeling, state space modeling, Bayes theorem modeling, quantitative trend spotting and dynamic factor analysis.

4. The method of claim 3, wherein said time series time series modeling is a vector autoregression.

5. The method of claim 3, wherein said near real time blood glucose forecast calculation includes at least one indicator variable, wherein said at least one indicator variable is selected from a group of seasonal factors, environmental factors, and lifestyle factors.

6. The method of claim 5, wherein said group of seasonal factors, environmental factors, and lifestyle factors includes a time of day, a day of the week, a month of the year, a current weather condition, a change in routine, a menstrual cycle status, a body weight change, a value representative of a current stress level, and a value representative of a current mood.

7. The method of claim 2, further comprising the step of continuously generating a personal patient history comprising a master event database and a master electronic calendar, wherein said master event database includes entries corresponding to at least a regular blood glucose reading and insulin intake quantity readings, and wherein each of said entries includes a date and time stamp.

8. The method of claim 7, wherein each of said entries further includes at least one associated valued from a master electronic calendar, and wherein said master electronic calendar stores periodic standard attributes and non-periotic personal patient attributes.

9. The method of claim 7, wherein said personal patient history includes an underlying general patient history derived from multiple individuals and an overlying personal patient history derived from a specific patient to perform the calculation of the single near real time blood glucose forecast, wherein said general patient history is derived from four or more patients.

10. A method of monitoring a near real time blood glucose forecast comprising the steps of:
determining a near real time blood glucose forecast; and
transmitting an alert based on said near real time blood glucose forecast, wherein said alert indicates an expected future high or low blood glucose level.

11. The method of claim 10, wherein said alert triggers a notifying event, and said notifying event is one of a group of notifying events including a telephone call, an electronic message, an audible cue, a vibration and the display of a symbol.

12. The method of claim 10, wherein said alert includes at least one recommended action for maintaining optimum blood glucose levels.

13. The method of claim 12, wherein said recommendation includes a recommended dosage of insulin and timing of said dosage of insulin.

14. The method of claim 10, wherein said step of determining a near real time blood glucose forecast is performed by a computerized device local to a user, wherein said computerized device is one of a medical device, a portable phone, a personal computer, and a portable tablet.

15. The method of claim 14, further comprising the additional step of displaying a determined near real time blood glucose forecast on a display screen of said computerized device.

16. The method of claim 10, wherein said step of determining a near real time blood glucose forecast is performed on a remote computerized device remote from a user in near-real time.

17. The method of claim 16, further comprising the step of transmitting a determined near real time blood glucose forecast from said remote computerized device to a local computerized device in close physical proximity to a user.

18. The method of claim 10, further comprising the step of allowing remote access to the near real time blood glucose forecast such that an authorized third party can access the determined a near real time blood glucose forecast.

19. The method of claim 10, further comprising the step of using the near real time blood glucose forecast data to determine the dosage of insulin to administer at any moment in time via an automated medical device.

20. A blood glucose forecasting system including a near real time blood glucose forecast comprising:
a processor;
a computer readable memory storing instructions for causing the processor to perform the steps of calculating a near real time blood glucose forecast based on frequently updated data representative of blood glucose levels and displaying the near real time blood glucose forecast, thereby allowing a user to determine an appropriate dosage based on said near real time blood glucose forecast;
a data input operable to at least receive periodic data representative of blood glucose levels;
an output medium comprising at least one of the list of a portable device screen, an electronic message transmission, and an audible output component.

21. The blood glucose forecasting system of claim 20, wherein said blood glucose meter further comprises a wireless transmitter/receiver operable to allow said blood glucose meter to receive wireless inputs and transmit wireless reports.
